(19) United States
(12) Patent Application Publication
(10) Pub. No.: US 2013/0337952 A1
(43) Pub. Date: Dec. 19, 2013

(54) PULLEY DEVICE FOR AN AIR CONDITIONING COMPRESSOR

(71) Applicants: Nicolas Berruet, Artannes sur Indre (FR); Richard Corbett, FONDETTES (FR); Samuel Viault, SAINT ANTOINE DU ROCHER (FR)

(72) Inventors: Nicolas Berruet, Artannes sur Indre (FR); Richard Corbett, FONDETTES (FR); Samuel Viault, SAINT ANTOINE DU ROCHER (FR)

(73) Assignee: AKTIEBOLAGET SKF, Goteborg (SE)

(21) Appl. No.: 13/901,681

(22) Filed: May 24, 2013

(30) Foreign Application Priority Data
May 24, 2012 (FR) 1254782

(51) Int. Cl. F16H 55/36

(52) U.S. Cl. CPC F16H 55/36
USPC 474/94

(57) ABSTRACT

Pulley device for a rotating machine comprising a pulley containing a plurality of axial ribs, a torque transmission means containing an axial sleeve intended to be installed on a rotating shaft of the rotating machine and a radial plate extending radially from the axial sleeve and comprising a plurality of regularly distributed radial teeth extending towards the outside, two adjacent teeth being separated in the circumferential direction by an indentation, and a damping element arranged between the said pulley and the torque transmission means.

The damping element includes at least one damping portion arranged in each of the indentations of the radial plate, being situated circumferentially between a radial tooth of the torque transmission means and an axial rib of the pulley.

### CROSS-REFERENCE TO RELATED APPLICATIONS

This application claims priority to French patent application no. 1254782 filed May 24, 2012, the contents of which are fully herein incorporated by reference.

### FIELD OF THE INVENTION

The present invention relates to the field of devices for transmitting torque between a drive pulley device and a shaft driven by the pulley. A torque transmission device of this type may be utilized, in particular, in air conditioning compressors such as those which are installed in motor vehicles.

### BACKGROUND OF THE INVENTION

A drive belt, connected to the engine by means of a crankshaft pulley, may decelerate harshly, whereas a driven pulley, for example an alternator pulley, exhibits a tendency, due to inertia, to continue to rotate at the same speed.

In the case of a rigid attachment between the crankshaft pulley and the transmission shaft, the belt is subjected to very high stresses at the time of these instantaneous variations in speed. Such variations are able to generate abnormal fatigue in the belt, for example, with the associated risks of rupture, slipping of the belt on the pulley, or even vibration of the belt runs between the pulleys.

In order to mitigate these phenomena, means for limiting the torque have been incorporated between the driven pulley and the driven shaft, in order to counteract the adverse effects of the rotational irregularities or sudden decelerations of the engine which occur in internal combustion engines, in particular at low revolutions and especially in Diesel engines. In this manner, in the case of excessive torque resulting, for example, from seizure of the air conditioning compressor, the pulley may continue to rotate without driving the shaft or without slipping relative to the drive belt, which would rapidly result in the destruction of this belt.

A damping element may similarly be provided between the pulley and the transmission shaft, in order to filter the rotational irregularities of the engine and the vibrations due to the rotation of the transmission shaft.

Document EP 0 702 167 (Denso) describes a device for transmitting torque between a pulley and a transmission shaft by means of two retention means, arranged between which is an elastic ring.

A structure of this kind is difficult to implement, however, as a result of the utilization of several retention means and does not permit sufficient filtering of the rotational irregularities of the engine or the vibrations of the transmission shaft.

Document FR 2 853 373 (Hutchinson) describes a pulley device comprising a pulley, a torque limiter and an elastic ring arranged between the pulley and the torque limiter. The elastic ring comprises a central annular core, radial projections extending towards the outside and capable of interacting with the pulley and radial projections extending towards the inside and capable of interacting with the torque limiter, so that the feet of the projections work under shear stress.

Such an elastic element does not permit the filtering of the rotational irregularities of the engine in an effective manner. Furthermore, the elastic element is heavily loaded in shearing, so that its service life is reduced.

### SUMMARY OF THE INVENTION

The object of the present invention is thus to overcome these disadvantages.

The object of the present invention is a pulley device for an air conditioning compressor capable of effectively filtering any rotational irregularities generated by the engine and transmitted to the belt and similarly integrating a torque limiter system. The service life of the belt is increased as a result.

According to one embodiment, the invention relates to a pulley device for a rotating machine comprising a pulley containing a plurality of axial grooves, a means for the transmission of torque containing an axial sleeve intended to be installed on a rotating shaft of the rotating machine and a radial plate extending radially from the axial sleeve and comprising a plurality of regularly distributed radial teeth extending towards the outside, two adjacent teeth being separated in the circumferential direction by an indentation, and a damping element arranged between the said pulley and the torque transmission means.

The damping element comprises at least one damping portion arranged in each of the indentations of the radial plate by being situated circumferentially between a radial tooth of the torque transmission means and a rib of the pulley.

Thus, the particular form of the damping element makes it possible for some of the circumferentially situated elastic material to be present between a tooth of the torque transmission means and a rib of the pulley and for it to work only in compression. The rotational irregularities of the engine and the vibrations are thus effectively filtered by the damping element.

Advantageously, the damping element comprises an inner housing made in its thickness and exhibiting a form which matches that of the radial plate of the torque transmission means.

Advantageously, the damping element comprises a recess between the damping portion and a radial tooth of the torque transmission means, the said recess being intended to interact with an axial rib of the pulley.

The damping element may comprise two damping portions situated in each of the indentations of the radial plate of the torque transmission means to either side of the recess. For example, the damping portions are of substantially equal thickness when the device is at rest.

The inner housing of the damping element may delimit a radial portion for the absorption of vibrations situated radially between an inner peripheral surface of an indentation of the torque transmission means and a rib of the pulley and circumferentially between two adjacent radial teeth.

According to one embodiment, the recess presents an opening emerging on the peripheral outside surface of the damping element.

According to another embodiment, the teeth of the torque transmission means extend radially as far as the outer peripheral surface of the damping element.

According to another embodiment, each damping portion comprises at least one transcurrent hole passing through the thickness of the damping element.

The transcurrent hole is of circular, rectangular or square form, for example.

Advantageously, the damping element is overmoulded onto the torque transmission means.

The damping element may comprise for this purpose axial overmoulding pads extending axially into the inner housing and intended to interact with a corresponding drilling made in the radial plate of the torque transmission means.

Advantageously, the damping element is overmoulded onto the pulley.

The damping element is preferably made of an elastic material, such as thermoplastic elastomer (TPE).

Advantageously, the torque transmission means is a torque limiter. In particular, this torque limiter may be provided with frangible means assuring the disconnection of the rotating shaft from the pulley in the case of the torque being greater than a threshold value.

The invention similarly relates to a rotating machine comprising a hollow coaxial shaft, a transmission shaft and a pulley device according to any of the preceding embodiments.

### BRIEF DESCRIPTION OF THE DRAWINGS

Other aims, characteristics and advantages of the invention will become apparent from a reading of the following description, which is provided solely by way of example without limitation and is given with reference to the accompanying drawings, in which:

FIG. 1 is a front view of a pulley device according to a first embodiment of the invention;

FIG. 2 is a view in the cross-section II-II of the pulley device according to FIG. 1, installed on a shaft of an air conditioner for a motor vehicle;

FIG. 3 is a view in the cross-section III-III of the pulley device according to FIG. 1;

FIG. 4 is a view in the cross-section IV-IV of the pulley device according to FIG. 3;

FIG. 5 illustrates the pulley device according to FIG. 4 set in rotation;

FIG. 6 is a perspective view of a damping element according to the first embodiment;

FIG. 7 is a cross-sectional view of a pulley device according to a second embodiment;

FIG. 8 is a perspective view of a damping element according to the second embodiment;

FIG. 9 is a cross-sectional view of a pulley device according to a third embodiment;

FIG. 10 is a view in the cross-section X-X of the pulley device according to FIG. 9;

FIG. 11 is a perspective view of a damping element according to the third embodiment;

FIG. 12 is a cross-sectional view of a pulley device according to a fourth embodiment;

FIG. 13 is a view in the cross-section XIII-XIII of the pulley device according to FIG. 12;

FIG. 14 illustrates the pulley device according to FIG. 13 set in rotation; and

FIG. 15 is a perspective view of a damping element according to the fourth embodiment.

### DETAILED DESCRIPTION OF THE INVENTION

As depicted in the Figures, the illustrative embodiment of the invention relative to a pulley device bearing the reference 1 in its entirety is intended to be installed in an air conditioning compressor on board a motor vehicle.

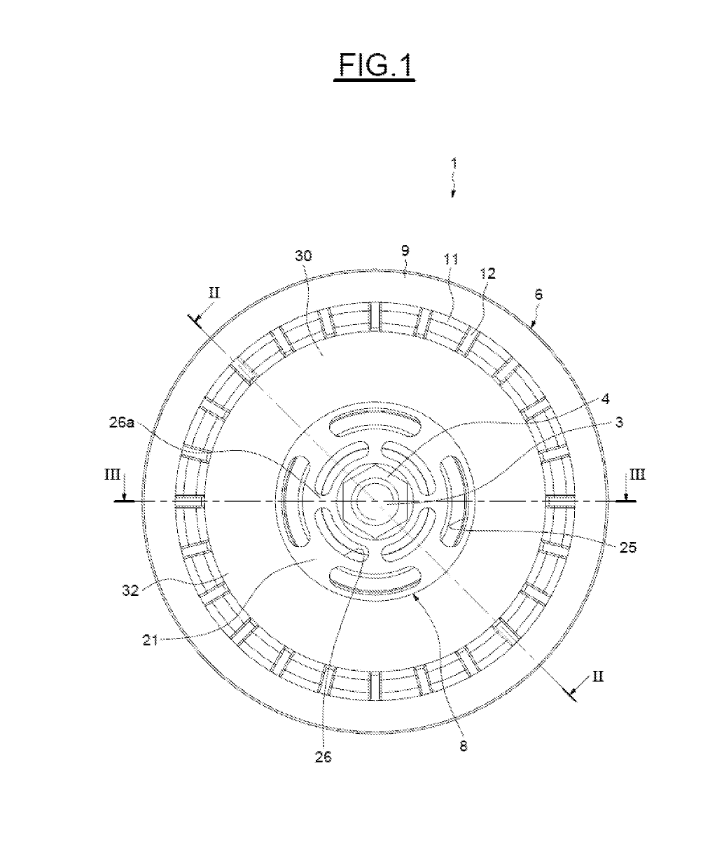

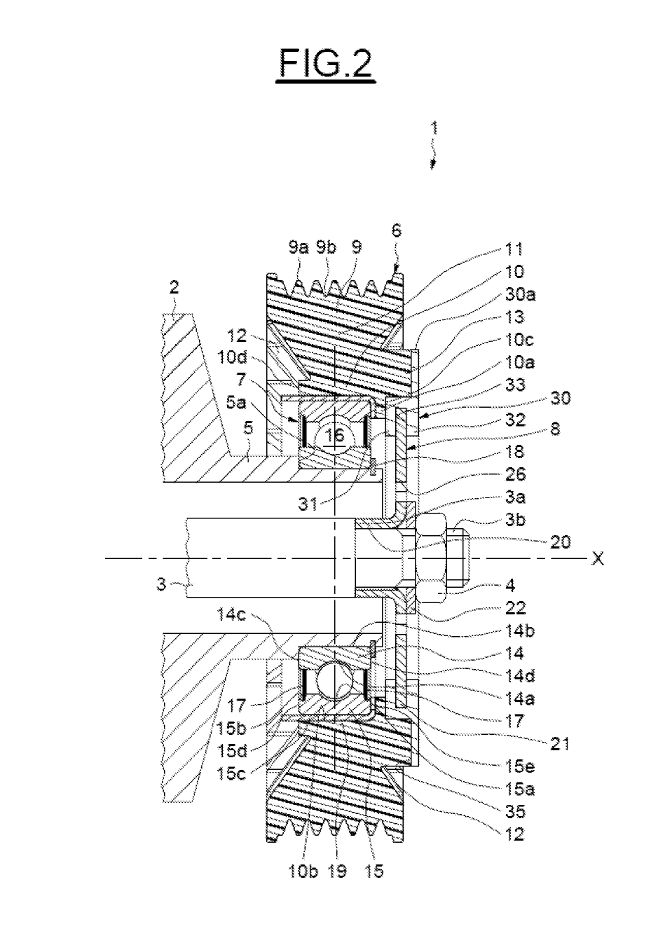

In the embodiment illustrated in FIGS. 1 and 2, the pulley device 1 is installed in a compressor comprising a non-rotating housing 2 and a transmission shaft 3 having an axis of rotation X. The transmission shaft 3, illustrated in detail in FIG. 2, comprises a shoulder 3a and a threaded portion 3b intended to interact with a nut 4. The housing 2 comprises a hollow shaft 5 that is coaxial with the transmission shaft 3.

As illustrated in the Figures, the pulley device 1 comprises a pulley 6, a roller bearing 7 and a torque transmission means, being a torque limiter 8 in the example presented here.

More precisely, the pulley 6 comprises an outer axial portion 9 presenting an outer surface intended to interact with a belt or a chain (not illustrated), an inner axial portion 10 and an intermediate radial annular portion 11 connecting the said inner and outer portions 9, 10. The outer and inner portions 9, 10 are coaxial with the axis of rotation X. The inner axial portion 10 comprises a radial rim 10a facing radially towards the inside from its axial extremities, a bore 10b in which the roller bearing 7 can be housed, and two lateral surfaces 10c, 10d. Reinforcing ribs 12 are similarly provided between the inner and outer axial portions 9, 10 and are connected together on the intermediate portion 11.

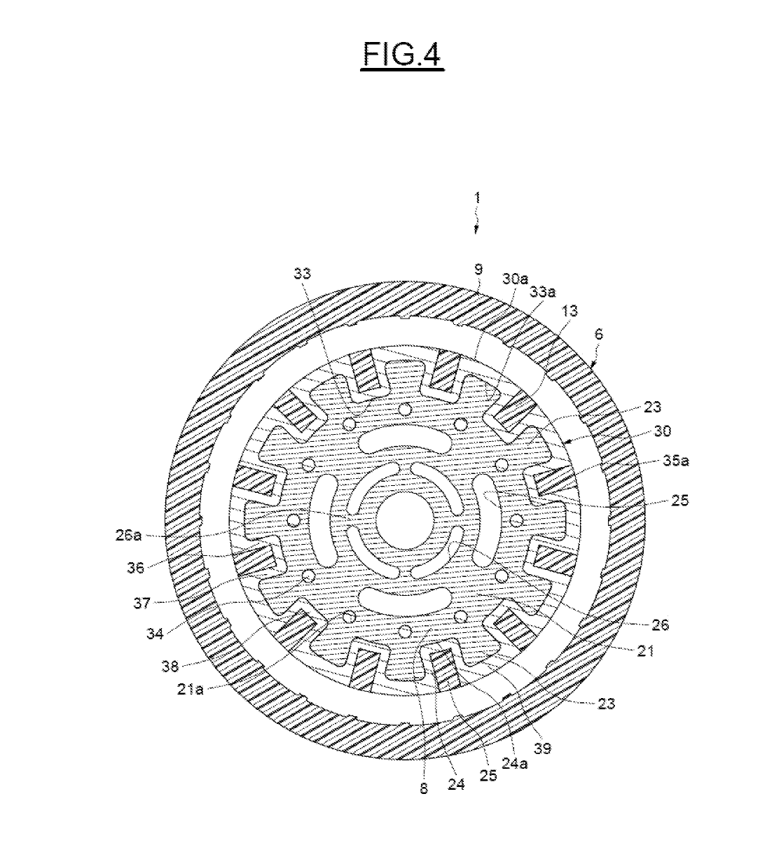

The outer cylindrical surface of the outer axial portion 9 is equipped with ribs 9a defining between them throats 9b, on the inside of which are accommodated V-belts or a single belt containing corresponding ribs, the said belt not being illustrated in the Figures. One of the lateral surfaces 10c of the pulley 6, opposite the housing 2, comprises a plurality of axial ribs 13, for example of square or rectangular form, extending axially from the lateral radial surface 10c of the side opposite the housing 2 towards the outside. The axial ribs 13, which are visible in detail in FIG. 4, are distributed regularly in the circumferential direction of the lateral radial surface 10c.

The roller bearing 7 contains an inner ring 14, an outer ring 15, a row of rolling elements 16, in this case realized in the form of balls arranged between bearing raceways 14a, 15a of the rings 14, 15, a cage (not illustrated) assuring the maintenance of the circumferential spacing of the rolling elements 16, and two sealing joints 17 that are symmetrical in relation to a radial plane passing through the centre of the rolling elements 16.

The inner ring 14 contains an outer circular axial surface, in which are arranged the toroidal bearing raceway 14a for the rolling elements 16, a bore 14b in contact with the outer cylindrical surface of the hollow shaft 5 and two lateral radial surfaces 14c, 14d. One of the lateral surfaces 14c is in axial contact with a shoulder 5a of the hollow shaft 5, and the other lateral surface 14d is in axial contact with an axial retention means 18, such as a circlip, for example.

The outer ring 15 is equipped with a bore, in which are arranged the toroidal bearing raceway 15a for the rolling elements 16, and grooves 15b, into which the sealing joints 17 are pressed, an outer circular axial surface 15c being pressed into the bore 10b of the pulley 6 via the intermediary of an annular flange 19 in the form of an L and two lateral radial surfaces 15d, 15e. One of the lateral surfaces 15e bears axially against the radial rim 10a of the pulley 6. The annular flange 19 comprises an axial portion (not referenced) intended to be folded in order to retain the outer ring 15 of the roller bearing 7 axially. As an alternative, the pulley 6 could be obtained by the overmoulding directly onto the outer ring 15 of a plastic material, such as a polyamide. This results in an excellent cohesion between these components. The realization of the pulley 6 by moulding permits it to be given complex forms while maintaining considerable lightness and relatively low manufacturing costs. Of course, the pulley 6 could be made of sheet metal as an alternative and could be pressed directly onto the outer ring 15.

As illustrated, the torque limiter 8, made by stamping a metal sheet, comprises an axial sleeve 20 and a radial plate 21 extending radially from the axial sleeve 20 towards the outside. The radial plate 21 and the axial sleeve 20 form a single component. The axial sleeve 20 is attached to the transmission shaft 3 in the vicinity of the extremity of the shaft between the shoulder 5a and the nut 6 via a washer 22. The radial plate 21 exhibits the general form of a disc and comprises a plurality of regularly distributed radial teeth 23 extending radially towards the outside. Two adjacent teeth 23 are separated in the circumferential direction by an indentation 24.

The radial plate 21 in addition comprises a first series of transcurrent drillings 25 of elongated form, for example being four in number, which are regularly distributed circumferentially and are angularly equidistant one from the other, in order to permit the insertion of an assembly tool (not illustrated). As an alternative, a different number of drillings or drillings of different form could be provided. The radial plate 21 similarly comprises a second series of transcurrent drillings 26 of elongated form, for example being four in number, which are angularly equidistant one from the other, centred on the same circle and arranged between the first series of drillings 25 and the axial sleeve 20. Two adjacent drillings 26 are spaced circumferentially by a portion 26a intended to rupture when the torque transmitted by the pulley 6 to the transmission shaft 3 exceeds a threshold value, for example 50 Nm.

The pulley device 1 comprises a damping element 30 arranged between the pulley 6 and the torque limiter 8, in order to filter the rotational irregularities of the engine and the vibrations of the transmission shaft 3.

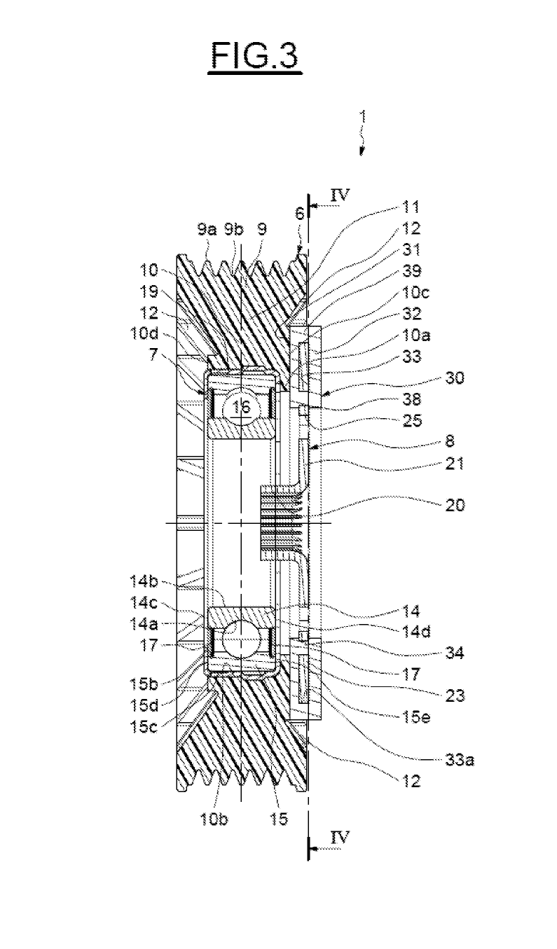

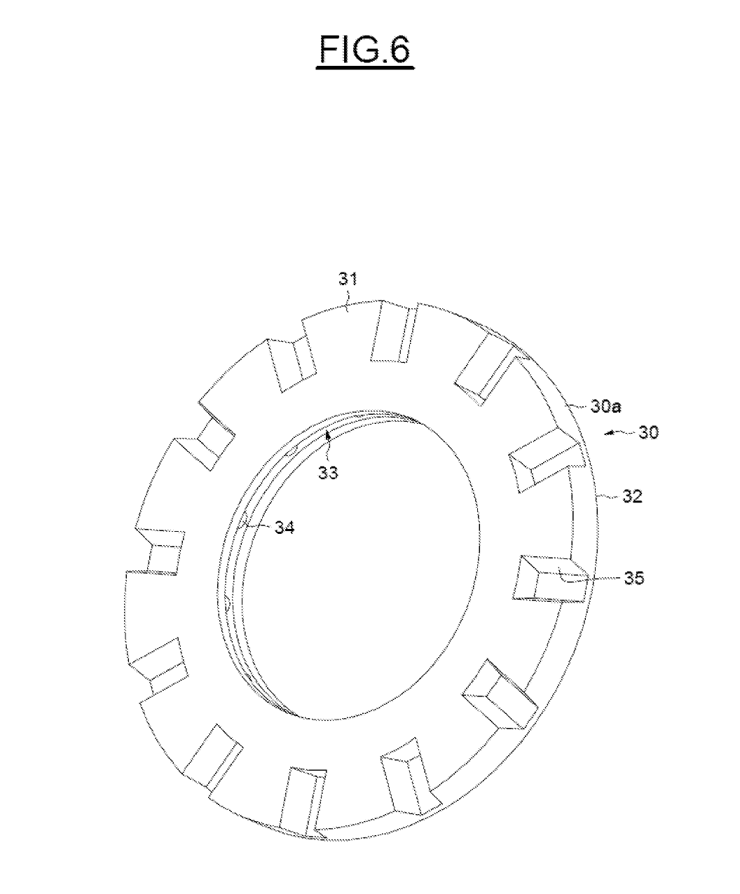

As illustrated in FIGS. 1 to 6, the damping element 30 exhibits the general form of a crown comprising a first lateral wall 31 and a second lateral wall 32, situated between which is an inner housing 33 made in its thickness emerging radially into a bore (not referenced) having a diameter greater than the diameter of the transmission shaft. The inner housing 33 exhibits a form which matches that of the radial plate 21 of the torque limiter 8, that is to say that the inner housing 33 exhibits a plurality of cavities 33a in the form of a dovetail, in which cavities the teeth 23 of the radial plate 21 of the torque limiter 8 are accommodated. As an alternative, the teeth 23 and the corresponding cavities 33a could exhibit any other form, such as rectangular, for example. The first lateral wall 31 bears axially against the lateral radial surface 10c of the pulley 6, and the second lateral wall 32 faces towards the outside of the pulley device 1.

The damping element 30, made of an elastic material such as thermoplastic elastomer (TPE), for example, is overmoulded onto the torque limiter 8 and comprises for this purpose axial overmoulding pads 34 extending axially into the inner housing 33 between the walls 31, 32 of the damping element 30 in order to interact with corresponding drillings 21a made in the radial plate 21 of the torque limiter 8.

The damping element 30 comprises a plurality of recesses 35, each intended to interact with an axial rib 13 of the pulley 6. Each recess 35 exhibits a form which matches that of the corresponding axial rib 13 and emerges via an opening 35a on the outer peripheral surface 30a of the damping element 30. As illustrated, the recess 35 is not transcurrent.

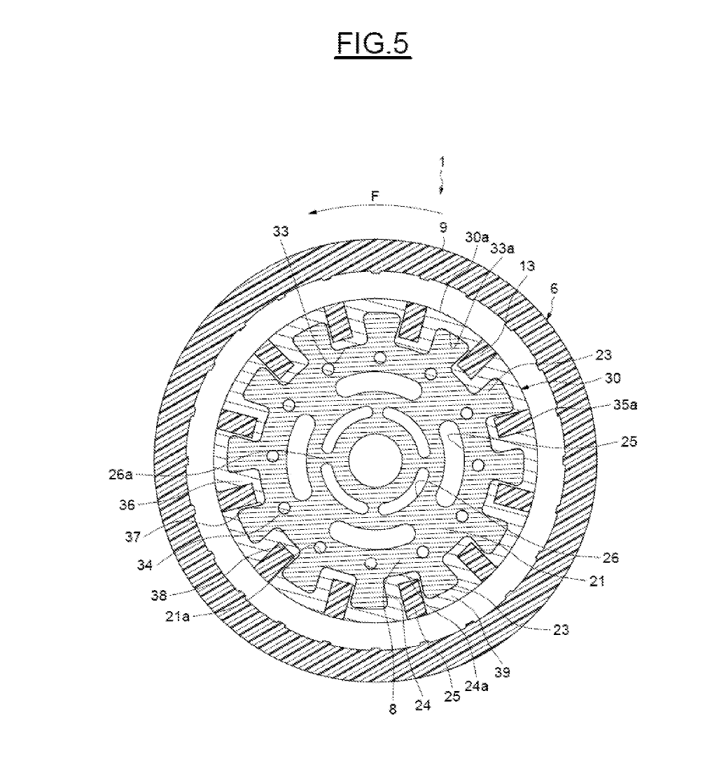

In the illustrated example, the damping element 30 comprises two damping portions 36, 37 arranged in each of the indentations 24 of the radial plate 21. Each damping portion 36, 37 is situated circumferentially between a radial tooth 23 of the torque limiter 8 and an axial rib 13 of the pulley 6, to either side of the recess 35. The circumferential position of the damping portions 36, 37 between a radial tooth 23 and an axial rib 13 permits these damping portions to work only in compression, as explained below in particular with reference to FIG. 5.

As illustrated, the damping portions 36, 37 are of substantially equal thickness when the device is at rest. As an alternative, provision could be made for a single unique damping portion between a tooth 23 of the torque limiter 8 and an axial rib 13 of the pulley 6.

The inner housing 33 of the damping element 30 delimits a radial portion 38 for the absorption of vibrations situated radially between an inner peripheral surface 24a of an indentation 24 of the torque limiter 8 and an axial rib 13 of the pulley 6 and circumferentially between two adjacent radial teeth 23.

In the example illustrated in FIGS. 1 to 6, the cavities 33a of the inner housing 33 are delimited radially by an outer radial portion 39.

FIG. 5 represents the pulley device 1 set in rotation. During rotation of the transmission shaft 3 in the direction of the arrow F, each of the ribs 13 of the pulley 6 compresses one of the damping portions 37 of the damping element 30 circumferentially against the teeth 23 of the radial plate 21 of the torque limiter 8. The ribs 13 of the pulley 6 then cause the rotation of the teeth 23 of the torque limiter 8 via the damping element 30. The attenuation of the vibrations and of any variations in speed between the pulley 6 and the transmission shaft 3, via the torque limiter 8, are damped exclusively by the compression of the damping portions 37 (rotation in the direction of F) or 36 (rotation in the direction opposite to F).

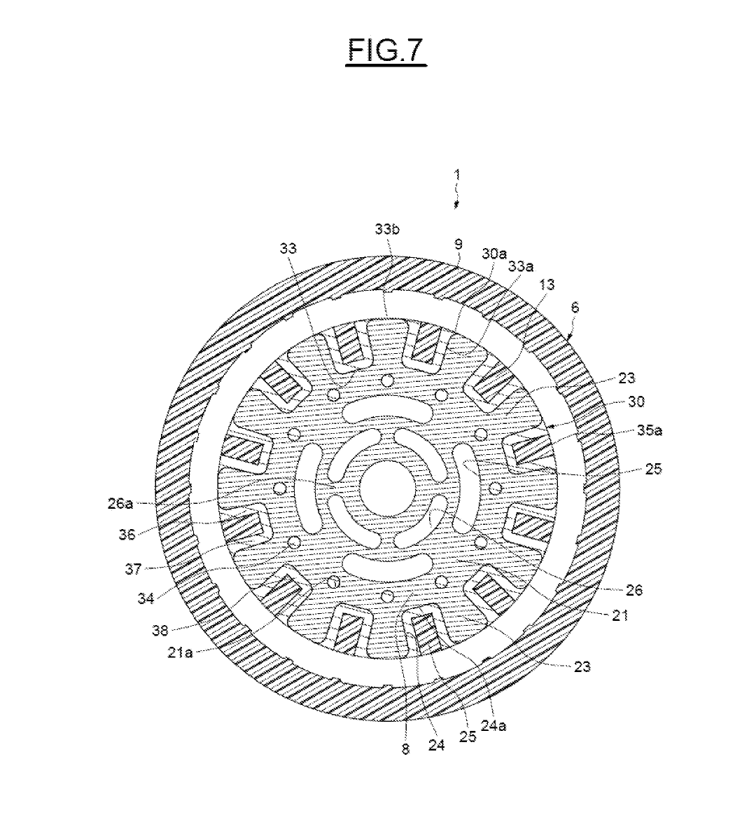

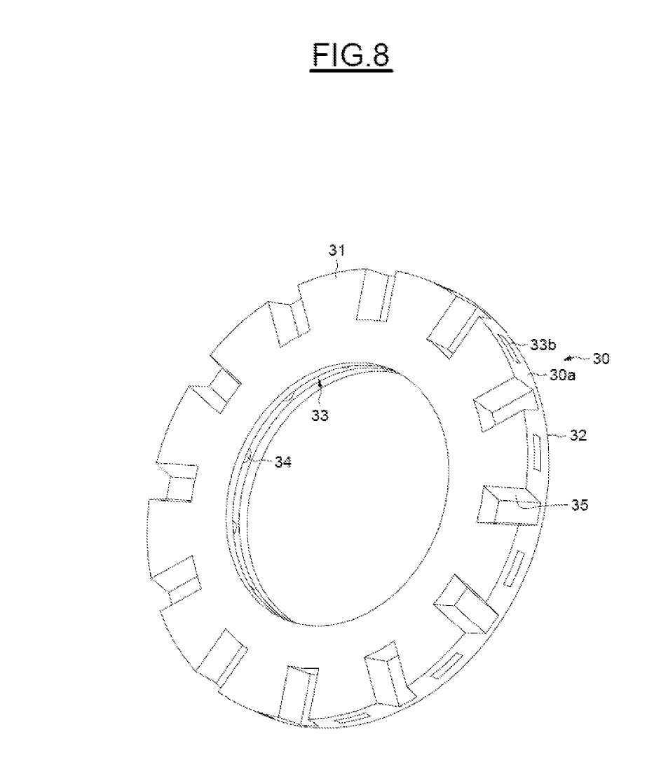

The embodiment illustrated in FIGS. 7 and 8, in which the same elements have the same references, differs from the embodiment illustrated in FIGS. 1 to 6 by the form of the damping element 30.

As illustrated in FIGS. 7 and 8, each cavity 33a of the damping element 30 emerges radially via an opening 33b towards the outside of the damping element 30, so that the teeth 23 of the torque limiter 8 extend radially as far as the outer peripheral surface 30a of the damping element.

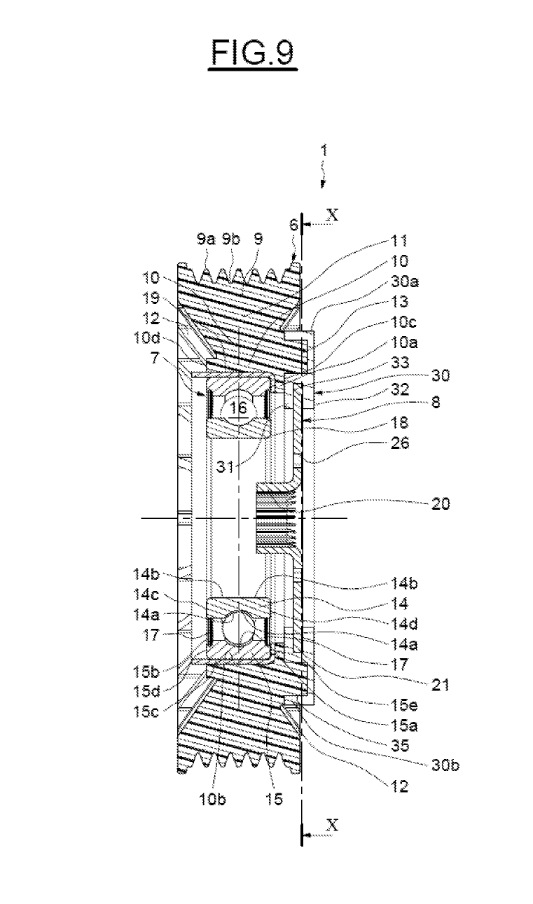

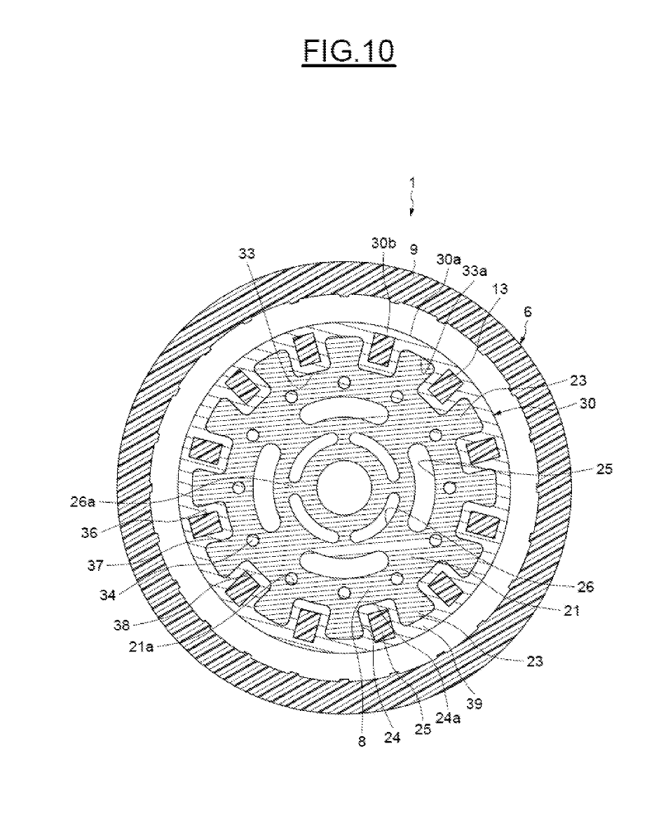

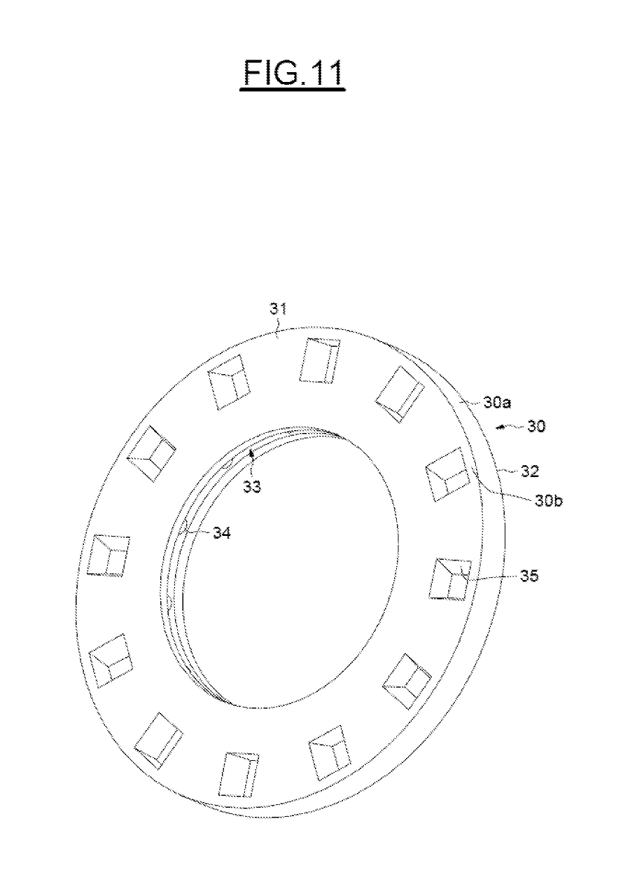

The embodiment illustrated in FIGS. 9 to 11, in which the same elements have the same references, differs from the embodiment illustrated in FIGS. 1 to 6 by the form of the damping element 30.

As illustrated in FIGS. 9 to 11, the recess 35 made on the first lateral surface 31 of the damping element 30 does not emerge on the outer peripheral surface 30a of the damping element 30, that is to say that the recess 35 is surrounded by an outer radial portion 30b of the damping element 30.

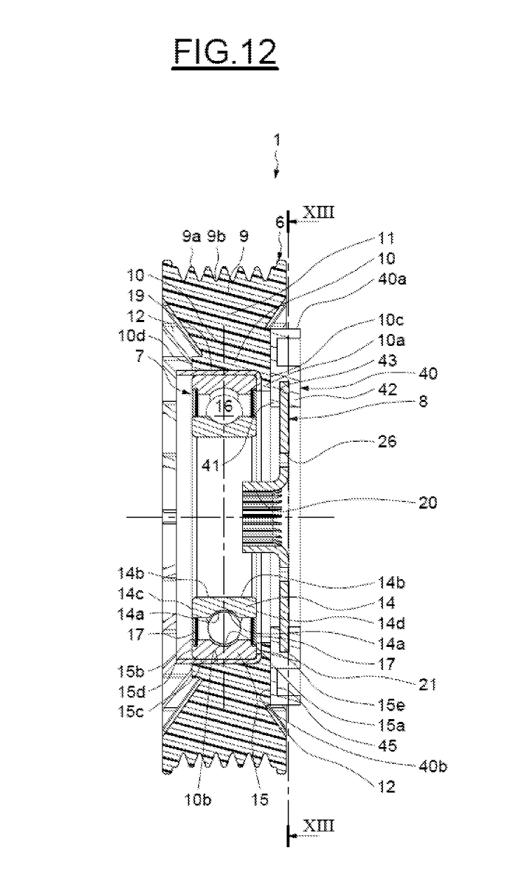

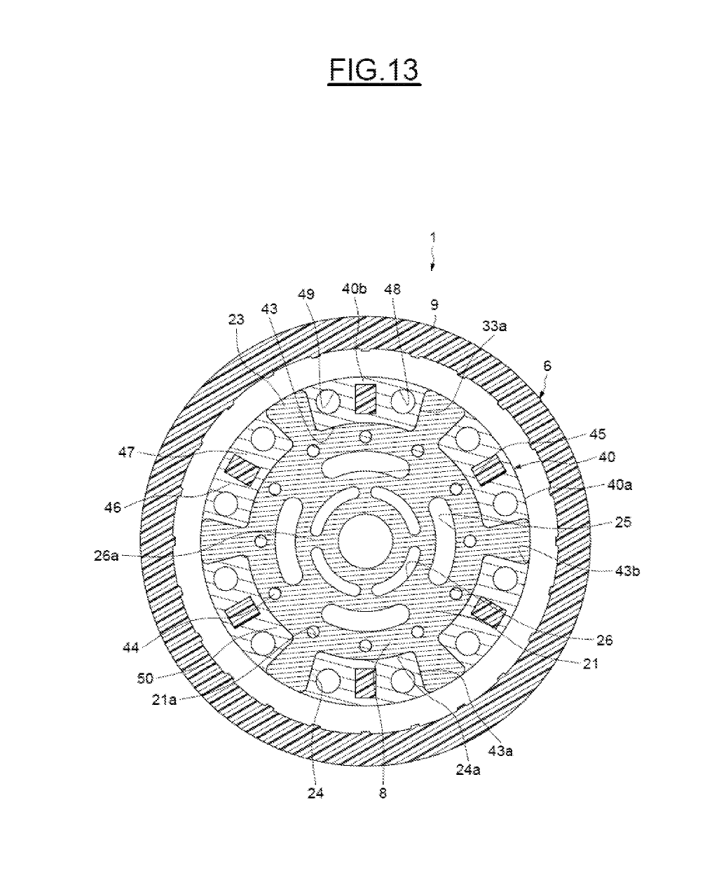

The embodiment illustrated in FIGS. 12 to 15, in which the same elements have the same references, differs from the embodiment illustrated in FIGS. 1 to 6 by the form of the damping element.

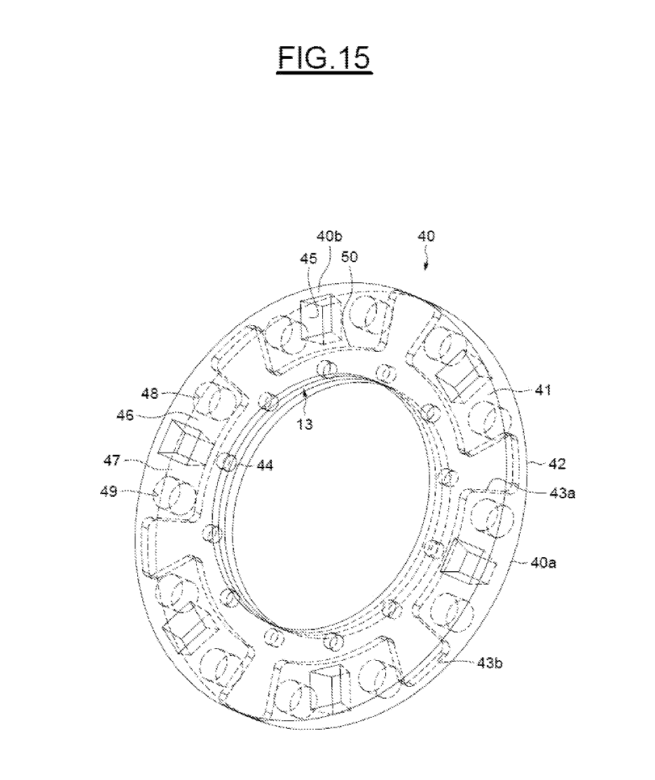

As illustrated in FIGS. 12 to 15, the damping element 40 exhibits the general form of a crown comprising a first lateral wall 41 and a second lateral wall 42, situated between which is an inner housing 43 made in the thickness thereof and emerging radially into a bore (not referenced) having a diameter greater than the diameter of the transmission shaft. The inner housing 43 possesses a form which matches that of the radial plate 21 of the torque limiter 8, that is to say that the inner housing 43 exhibits a plurality of cavities 43a in the form of a dovetail, in which the teeth 23 of the radial plate 21 of the torque limiter 8 are accommodated, made in the thickness thereof and having a form matching the radial plate 21 of the torque limiter 8. The inner housing 43 is represented as dotted lines in FIG. 15.

The damping element 40, made of an elastic material such as thermoplastic elastomer (TPE), for example, is overmoulded onto the torque limiter 8 and comprises for this purpose axial overmoulding pads 44 extending axially into the inner housing 43 between the walls 41, 42 of the damping element 40 in order to interact with corresponding drillings 21a made in the radial plate 21 of the torque limiter 8. The cavities 43a of the inner housing 43 emerge via an opening 43b towards the outside of the damping element 40, so that the teeth 23 of the torque limiter 8 extend radially as far as the outer peripheral surface 40a of the damping element 40. As an alternative, provision could be made for the extremity of each radial tooth 23 to be in contact with an outer radial portion of the damping element 40.

The damping element 40 comprises a plurality of recesses 45, each intended to interact with an axial rib 13 of the pulley 6. Each recess 45 possesses a form which matches that of the corresponding axial rib 13 and does not emerge on the outer peripheral surface 40a of the damping element 40. As an alternative, provision could be made for the recess 45 to emerge on the peripheral surface 40a of the damping element 40. As illustrated, the recess 45 is not transcurrent. In the illustrated example, the damping element 40 comprises two damping portions 46, 47 arranged in each of the indentations 24 of the radial plate 21. Each damping portion 46, 47 is situated circumferentially between a radial tooth 23 of the torque limiter 8 and an axial rib 13 of the pulley 6, to either side of the recess 45. The circumferential position of the damping portions 46, 47 between a radial tooth 23 and an axial rib 13 permits these damping portions to work only in compression.

As illustrated, the damping portions 46, 47 are of substantially equal thickness when the device is at rest. Each damping portion 46, 47 comprises a hole 48, 49 passing through the thickness of the damping element 40. As illustrated, each transcurrent hole 48, 49 is of circular form. As an alternative, the transcurrent hole could be of rectangular or square form. In the example illustrated in FIGS. 12 to 15, the torque limiter 8 comprises a number of radial teeth, for example being six in number, being lower than the number of teeth in the preceding embodiments, in order to delimit the larger indentations that are capable of accommodating the transverse holes 48, 49.

The inner housing 43 of the damping element 40 delimits an inner radial portion 50 for the absorption of any vibrations, situated radially between an inner peripheral surface 24a of an indentation 24 of the torque limiter 8 and an axial rib 13 of the pulley 6 and circumferentially between two adjacent radial teeth 23.

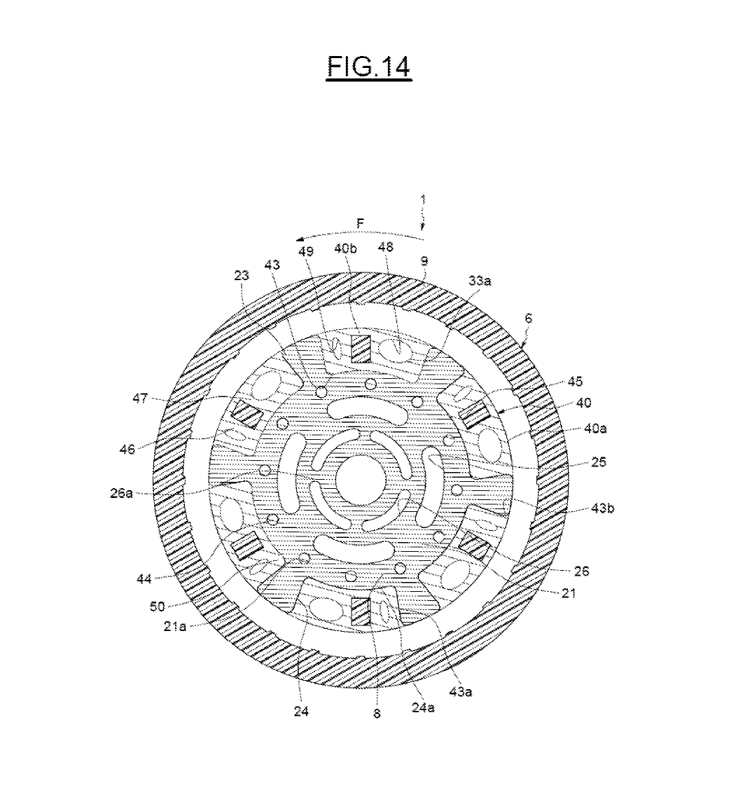

FIG. 14 depicts the pulley device 1 set in rotation. During rotation of the transmission shaft 3 in the direction of the arrow F, each of the ribs 13 of the pulley 6 compresses one of the damping portions 46 of the damping element 40 circumferentially against the teeth 23 of the radial plate 21 of the torque limiter 8. The ribs 13 of the pulley 6 then cause the rotation of the teeth 23 of the torque limiter 8 via the damping element 40. The attenuation of the vibrations and of any variations in speed between the pulley 6 and the transmission shaft 3, via the torque limiter 8, are damped exclusively by the compression of the damping portions 46 (rotation in the direction of F) or 47 (rotation in the direction opposite to F). Compression is facilitated by the transcurrent holes 48, 49 made in each of the damping portions 46, 47.

In each of the embodiments, the damping element is overmoulded onto the torque limiter and onto the pulley. As an alternative, provision could be made for the damping element to be overmoulded only onto the pulley.

The invention is not restricted to the embodiments described here and may be subject to various alternatives.

Thanks to the invention, it is possible to manufacture and assemble, in a simple, economic and easy manner, a unit made up of the pulley, the bearing, the torque limiter and the damping element, the said unit being capable of being transported subsequently without the risk of disconnection of these elements and being ready to be attached to the associated support.

The invention may be applied advantageously to a rotating machine comprising a hollow coaxial shaft 5, a transmission shaft 3 and a pulley device 1 according to one of the preceding embodiments.

In addition, the particular form of the damping element makes it possible for some of the elastic material to be present circumferentially between a tooth of the torque limiter and a rib of the pulley and for it to work only in compression.

The rotational irregularities of the engine and the vibrations are thus effectively filtered by the damping element.

1. A pulley device for a rotating machine comprising:
a pulley (6) containing a plurality of axial grooves (13),
a means (8) for the transmission of torque containing an axial sleeve (20) intended to be installed on a rotating shaft (3) of the rotating machine and a radial plate (21) extending radially from the axial sleeve (20) and comprising a plurality of regularly distributed radial teeth (23) extending towards the outside, at least two adjacent teeth (23) being separated in the circumferential direction by an indentation (24), and a damping element (30, 40) arranged between the said pulley (6) and the torque transmission means (8), wherein
the damping element (30, 40) includes at least one damping portion (36, 37, 46, 47) arranged in each of the indentations (24) of the radial plate (21) by being situated circumferentially between a radial tooth (23) of the torque transmission means (8) and an axial rib (13) of the pulley (6).

2. The pulley device according to claim 1, wherein the damping element (30, 40) includes an inner housing (33, 43) made in its thickness and exhibiting a form which matches that of the radial plate (21) of the torque transmission means (8).

3. The pulley device according to claim 2, wherein the damping element (30, 40) includes a plurality of recesses (35, 45), each arranged between the damping portion (36, 37, 46, 47) and a radial tooth (23) of the torque transmission means (8), wherein
each of the recesses (35, 45) interact with an axial rib (13) of the pulley (6).

4. The pulley device according to claim 3, wherein the damping element (30, 40) includes two damping portions (36, 37, 46, 47) situated in each of the indentations (24) of the radial plate (21) of the torque transmission means (8) to either side of the recess (35, 45).

5. The pulley device according to claim 4, wherein the damping portions (36, 37, 46, 47) are of substantially equal thickness.

6. The pulley device according to claim 5, wherein the inner housing (33, 43) of the damping element (30, 40) delimits a radial portion (38, 50) for the absorption of vibrations situated radially between an inner peripheral surface (24a) of an indentation (24) of the torque transmission means (8) and an axial rib (13) of the pulley (6) and circumferentially between two adjacent radial teeth (23).

7. The pulley device according to claim 6, wherein the recess (35) presents an opening (35a) emerging on the outer peripheral surface (30a) of the damping element (30).

8. The pulley device according to claim 1, wherein the teeth (23) of the torque transmission means (8) extend radially as far as the outer peripheral surface (30a, 40a) of the damping element (30, 40).

9. The pulley device according to claim 1, wherein each damping portion (46, 47) comprises at least one transcurrent hole (48, 49) passing through the thickness of the damping element (40).

10. The pulley device according to claim 1, wherein the transcurrent hole (48, 49) is of circular, rectangular or square form.

11. The pulley device according to claim 1, wherein the damping element (30, 40) is overmoulded onto the torque transmission means (8).

12. Pulley device according to claim 11, wherein the damping element (30, 40) comprises axial overmoulding pads (34, 44) extending axially into the inner housing (33, 43) and intended to interact with a corresponding drilling (21a) made in the radial plate (21) of the torque transmission means (8).

13. The pulley device according to claim 1, wherein the damping element (30, 40) is overmoulded onto the pulley (6).

14. The pulley device according to claim 1, wherein the damping element (30, 40) is made of an elastic material.

15. A rotating machine comprising:
a hollow coaxial shaft (5),
a transmission shaft (3), and
a pulley device (1) including;
a pulley (6) containing a plurality of axial grooves (13),
a means (8) for the transmission of torque containing an axial sleeve (20) intended to be installed on a rotating shaft (3) of the rotating machine and a radial plate (21) extending radially from the axial sleeve (20) and comprising a plurality of regularly distributed radial teeth (23) extending towards the outside, at least two adjacent teeth (23) being separated in the circumferential direction by an indentation (24), and a damping element (30, 40) arranged between the said pulley (6) and the torque transmission means (8), wherein
the damping element (30, 40) includes at least one damping portion (36, 37, 46, 47) arranged in each of the indentations (24) of the radial plate (21) by being situated circumferentially between a radial tooth (23) of the torque transmission means (8) and an axial rib (13) of the pulley (6).
